(19) United States
(12) Patent Application Publication
(10) Pub. No.: US 2006/0070062 A1
(43) Pub. Date: Mar. 30, 2006

(54) Detecting previously installed applications using previously installed detection mechanisms separate from installer program

(75) Inventors: David E. Cox, Raleigh, NC (US); Craig M. Lawton, Raleigh, NC (US); Jonathan A. Lewis, Morrisville, NC (US); Christopher A. Peters, Round Rock, TX (US); Lorin E. Ullmann, Austin, TX (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 10/955,254

(22) Filed: Sep. 30, 2004

(51) Int. Cl. G06F 9/445

(52) U.S. Cl. 717/174

(57) ABSTRACT

A method, computer program product and system for detecting previously installed applications on a system. An installer program may invoke an application programming interface to call a software component, referred to as a “manager”, to detect previously installed applications on the system. The manager may be configured to query detection mechanisms, referred to as “collectors”, to perform their own detection techniques to detect applications installed on the system. Since each collector may perform its own unique detection technique, the collectors may be used together to detect more applications installed on the system than if the installer program attempted to detect the applications installed on the system by itself.

### TECHNICAL FIELD

The present invention relates to the field of installation programs, and more particularly to detecting applications previously installed on a computer system, apart from the installation of a software application, thereby allowing disparate detection techniques to be combined to produce a generic detection technique to detect previously installed applications.

### BACKGROUND INFORMATION

An installer program is a software program that enables a programmer to write specific code to install a given application program onto the drives of a computer in a way that enables the given application program to work correctly with the computer's environment, including its operating system. There are several types of installers, such as Java installers and operating system specific installers, e.g., Microsoft Windows installers, International Business Machine's (“IBM's”) OS/2 and AIX operating system installers.

Typically, a developer of the installer program may define the rules for the installation. These rules may include the configuration activity required to install a particular software application. For example, a certain amount of free space on the computer system may be required in order to install the application. In another example, the user may have to supply a user name and password in order to install the application. These rules may also include a listing of required applications, e.g., a particular version of a particular application server, to have been previously installed on the computer system in order to install the application.

Prior to the actual installation of the application program, a software component, commonly referred to as a “detection mechanism”, in the installer program may be used to detect the applications installed on the computer system. The detection mechanism though may not be able to detect all the applications installed on the system for many reasons. For example, the detection mechanism of the installer program may have obsolete techniques in detecting applications on the system. In another example, the listing of required applications to have been previously installed on the system in order to install the application may contain an identification, e.g., new name, that may be unrecognizable by the detection mechanism. Further, the detection mechanism may not be able to identify the intended application (the application intended to be identified by the identification) because the intended application is identified with an older identification.

Thus, current installer programs implementing detection mechanisms may not be able detect all the applications installed on the system. By not being able to detect all the applications installed on the system, an application may not be allowed to be installed or an application that should not be installed may be installed anyway.

Therefore, there is a need in the art for a detection technique to be able to detect a greater number (if not all) of applications previously installed on the system.

### SUMMARY

The problems outlined above may at least in part be solved in some embodiments by having the installer program not perform the detection of applications installed on the computer system. Instead, the installer program may invoke an application programming interface to call a software component, referred to herein as a “manager”, separate from the installer program to detect the applications installed on the computer system. The manager may be configured to query detection mechanisms, referred to herein as “collectors”, to perform their own detection techniques to detect applications installed on the system. Since each collector may perform its own unique detection technique, the collectors may be used together to detect more applications installed on the system than if the installer program attempted to detect the applications installed on the system by itself.

In one embodiment of the present invention, a method for detecting previously installed applications on a system may comprise the step of installing a detection mechanism on the system during an installation of an application. The method may further comprise invoking an application programming interface to call a manager to detect previously installed applications on the system. The method may further comprise detecting previously installed applications on the system using previously installed detection mechanisms and the installed detection mechanism.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of software components used in detecting previously installed applications on the system; and

FIG. 3 is a flowchart of a method for detecting previously installed applications on the system in accordance with an embodiment of the present invention.

### DETAILED DESCRIPTION

The present invention comprises a method, computer program product and system for detecting previously installed applications on a system. In one embodiment of the present invention, an installer program may invoke an application programming interface to call a software component, referred to herein as a “manager”, to detect previously installed applications on the system. The manager may be configured to query detection mechanisms, referred to herein as “collectors”, to perform their own detection techniques to detect applications installed on the system. Since each collector may perform its own unique detection technique, the collectors may be used together to detect more applications installed on the system than if the installer program attempted to detect the applications installed on the system by itself.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

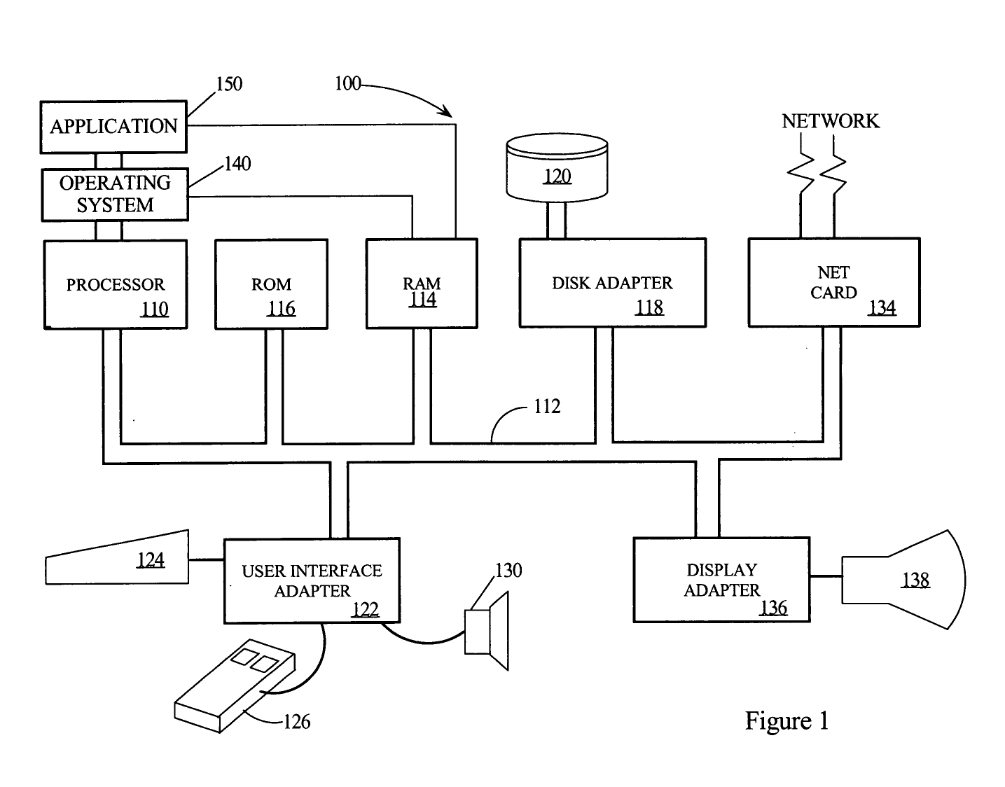

FIG. 1—Computer System

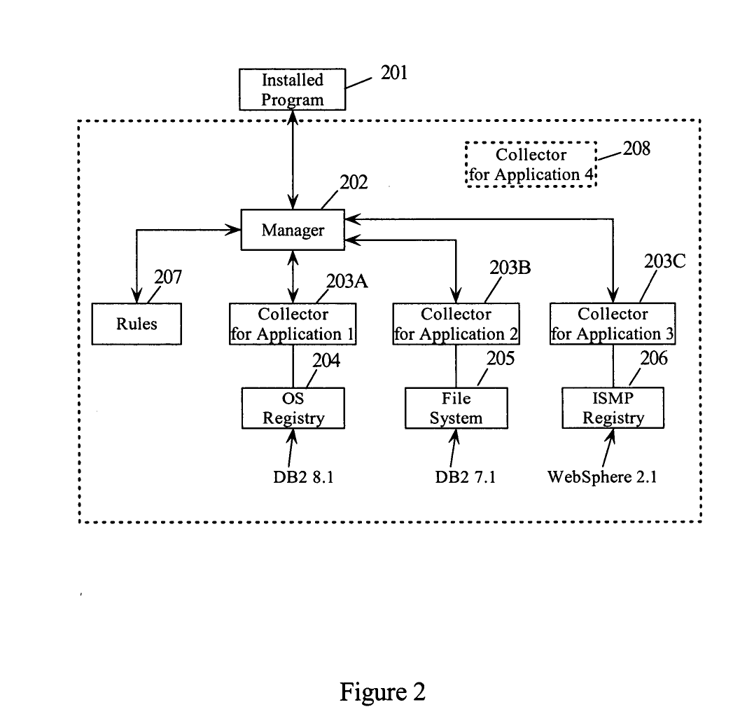

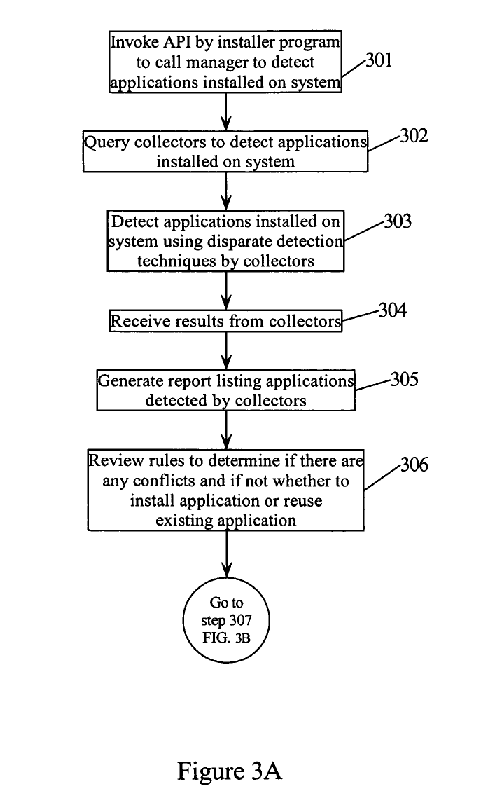

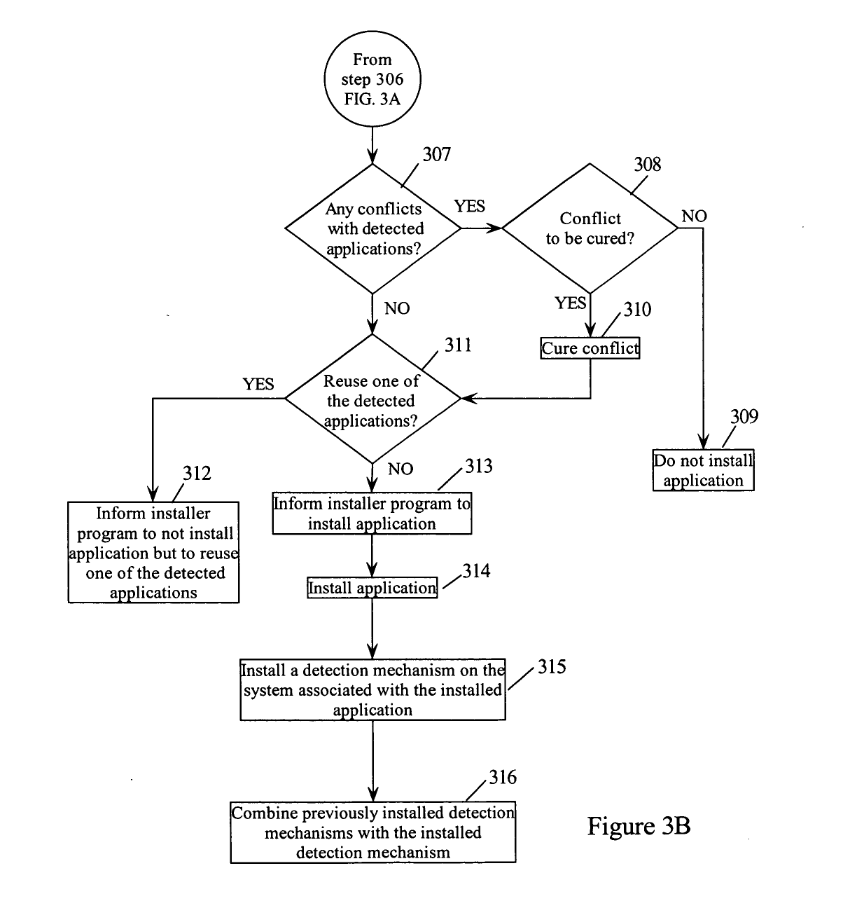

FIG. 1 illustrates a typical hardware configuration of computer system 100 which is representative of a hardware environment for practicing the present invention. Computer system 100 may have a processor 110 coupled to various other components by system bus 112. An operating system 140 may run on processor 110 and provide control and coordinate the functions of the various components of FIG. 1. An application 150 in accordance with the principles of the present invention may run in conjunction with operating system 140 and provide calls to operating system 140 where the calls implement the various functions or services to be performed by application 150. Application 150 may include, for example, an installer program, e.g., Platform Installation and Configuration Service (PICS). Application 150 may also include, for example, software components, separate from the installer program, used in detecting previously installed applications on system 100 as discussed further below in association with FIGS. 2-3. A more detail description of the software components used in detecting previously installed applications on system 100 is provided below in association with FIG. 2. FIG. 3 is a flowchart of a method for detecting previously installed applications using the software components described in association with FIG. 2.

Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and application 150 may be loaded into RAM 114 which may be computer system's 100 main memory for execution. Disk adapter 118 may be an integrated drive electronics (“IDE”) adapter that communicates with a disk unit 120, e.g., disk drive. It is noted that the installer program may reside in disk unit 120 or in application 150. It is further noted that the software components, separate from the installer program, used in detecting previously installed applications on system 100, as discussed in association with FIGS. 2-3, may reside in disk unit 120 or in application 150.

Referring to FIG. 1, computer system 100 may further comprise a network card 134 coupled to bus 112. Network card 134 may interconnect bus 112 with an outside network, e.g., Local Area Network (LAN), Wide Area Network (WAN), enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138 or speaker 130.

Implementations of the invention include implementations as a computer system programmed to execute the method or methods described herein, and as a computer program product. According to the computer system implementations, sets of instructions for executing the method or methods may be resident in the random access memory 114 of one or more computer systems configured generally as described above. Until required by computer system 100, the set of instructions may be stored as a computer program product in another computer memory, for example, in disk unit 120. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Software Components

FIG. 2 illustrates an embodiment of the present invention of the software components used in detecting previously installed applications on system 100 (FIG. 1). Referring to FIG. 2, an installer program 201 (referring to the installer program that may reside in either application 150 or in disk unit 120 as illustrated in FIG. 1), may invoke an application programming interface to call a software component, referred to herein as a manager 202, to detect applications installed on system 100. Manager 202 may be configured to query one or more detection mechanisms, referred to herein as “collectors” 203A-C, which are configured to detect applications installed on system 100 using individually distinct detection techniques. Collectors 203A-C may collectively or individually be referred to as collectors 203 or collector 203, respectively. Each collector 203 may be installed by a particular installer program during the installation of an application installed by that installer program. Further, each collector 203 may be configured to perform its own unique detection technique to locate the applications installed on system 100 thereby allowing a greater number of applications to be detected on system 100 than if installer program 201 alone detected the applications installed on system 100. It is noted that collector's 203 detection technique may be able to detect a proprietary application, such as a non-open database, that is intended to be kept secret or to be exclusively used by a particular party. For example, collector 203 may be configured to query a third party, such as an application external to computer 100, which may be configured to manage a proprietary application. The third party may, in response to the query from collector 203, inform collector 203 about the installation of the proprietary application. A more detail description of detecting previously installed applications on system 100 is provided further below.

As stated in the Background Information section, installer programs included a detection mechanism that was used to detect the applications installed on a computer system. However, the installer program's detection mechanism may not be able to detect all the applications installed on the system for a variety of reasons as discussed in the Background Information section. By not being able to detect all the applications installed on the system, an application may not be allowed to be installed or an application that should not be installed may be installed anyway. Therefore, there is a need in the art for a detection technique to be able to detect a greater number (if not all) of applications installed on the system.

A greater number of applications (if not all) that were previously installed on a system, such as system 100 (FIG. 1), may be detected by separating the detection feature (detecting installed applications) from the installer program. By separating the detection feature from the installation, installer program 201 may be able to call manager 202, a separate software component from installer program 201, to detect the applications installed on system 100. Manager 202 may, in turn, query each collector 203 to perform its own detection technique to detect applications installed on system 100. For example, collector 203A may search in operating system registry 204 for applications previously installed on system 100. Referring to FIG. 2, collector 203A (collector 203A may have installed by the installer program used to install DataBase 2 version 8.1) would detect that DataBase 2 (DB2) version 8.1 had been installed on system 100. Collector 203A may detect that DB2 version 8.1 had been installed on system 100 since operating system registry 204 may contain an entry that indicates that DB2 version 8.1 had been installed on system 100. Collector 203B (collector 203B may have been installed by the installer program used to install DB2 version 7.1), on the other hand, may search in file system 205 for applications previously installed on system 100. Referring to FIG. 2, collector 203B would detect that DB2 version 7.1 had been installed on system 100. Collector 203B may detect that DB2 version 7.1 had been installed on system 100 since file system 205 may contain an entry that indicates that DB2 version 7.1 had been installed on system 100. Collector 203C (collector 203C may have been installed by the installer program used to install WebSphere version 2.1 and/or DB2 version 7.1) may search in both operating system registry 204 and Integrated System Management Processor (ISMP) registry 206 for applications previously installed on system 100. Referring to FIG. 2, collector 203C would detect that DB2 version 7.1 had been installed on system 100 as well as that WebSphere version 2.1 has been installed on system 100. Collector 203C may detect that WebSphere version 2.1 had been installed on system 100 since ISMP registry 206 may contain an entry that indicates that WebSphere version 2.1 had been installed on system 100. Hence, by using multiple detection mechanisms (collectors 203A-C) with disparate detection techniques, a greater number of applications (if not all) that are installed on system 100 may be detected.

Upon collector 203 detecting application(s) installed on system 100, collector 203 may inform manager 202 of the application(s) it detected on system 100. Upon manager 202 receiving the results from each collector 203 implementing its detection technique to detect installed applications, manager 202 may be configured to generate a report listing the applications detected on system 100 by each collectors 203.

Manager 202 may further be configured to determine if there are any conflicts between the application to be installed by installer program 201 and the applications detected on system 100 by each collector 203. In one embodiment, manager 202 may determine if there are any conflicts between the application to be installed by installer program 201 and the applications detected on system 100 by each collector 203 by reviewing a rules database 207. Rules database 207 may include a listing of required applications, e.g., a particular version of a particular application server, to have been previously installed on system 100 in order to install the application. Rules database 207 may also include information regarding the ownership, e.g., owner of application to be installed, and performance parameters, e.g., amount of required free space on system 100 to install the application. In one embodiment, rules database 207 may be updated by an application being installed by installer program 201 (including future installer programs) during the installation of the application. Based on the information provided in rules database 207 regarding the application to be installed and the applications detected on system 100 by collectors 203, manager 202 may determine if there are any conflicts between the application to be installed by installer program 201 and the applications detected on system 100 by collectors 203.

If there are any conflicts detected by manager 202, then manager 202 may determine if the conflict can be cured. If so, then manager 202 cures the conflict. For example, suppose installer program 201 installs application A version 6.1 on system 100. Further suppose that there already exists application A version 3.0 on system 100. If application A version 6.1 modifies rules database 207 or transmits rules to manager 202 to modify rules database 207 that indicate that application A version 6.1 is incompatible with application A version 3.0, then manager 202 may determine that the conflict can be cured by deleting application A version 3.0 from system 100.

If, however, manager 202 determines that the conflict cannot be cured, then manager 202 informs installer program 201 to not install the application.

Manager 202 may further be configured to determine whether one of the detected applications should be reused instead of installing the application by installer program 201. Manager 202 may determine whether one of the detected applications should be reused instead of installing the application by installer program 201 by reviewing rules database 207. For example, if one of the detected applications is the same application, including version, as the application to be installed, then manager 202 may determine to reuse this application instead of having the application be installed by installer program 201. In another example, if one of the detected applications is the same application as the application to be installed except that it is an older version but would function satisfactorily according to the rules in rules database 207, then manager 202 may determine to reuse this application instead of having the application be installed by installer program 201.

If manager 202 determines that installer program 201 should install the application, then installer program 201 may install a collector 208, configured similarly as collector 203, during the installation of the application. Collector 208 may later be used by a subsequent installer program via manager 202 to detect applications on system 100.

Collector 208 may be configured to detect the application installed by installer program 201. For example, if installer program 201 is installing application #4, then collector 208 may be configured to detect the installation of application #4. Similarly, collectors 203A-C may each be configured to detect the installation of the application installed during its installation. For example, collector 203A may be configured to detect the installation of application #1 which was installed by the installer program which also installed collector 203A. Collector 203B may be configured to detect the installation of application #2 which was installed by the installer program which also installed collector 203B and so forth. Each collector, collector 203 and collector 208, may remain on system 100 even if the associated application were uninstalled. For example, collector 208 may remain on system 100 even if application #4 were uninstalled.

A description of detecting previously installed applications using the software components of FIG. 2 is described below in association with FIG. 3.

FIG. 3—Method for Detecting Previously Installed Applications on a System

FIG. 3 is a flowchart of one embodiment of the present invention of a method 300 for detecting previously installed applications on system 100 (FIG. 1).

Referring to FIG. 3, in conjunction with FIGS. 1-2, in step 301, installer program 201 invokes an Application Programming Interface (API) to call manager 202 to detect applications installed on system 100. By having the detection of applications installed on system 100 being performed by manager 202 via collectors 203 instead of by installer program 201, a greater number of applications may be detected on system 100 since disparate detection techniques may be implemented together to detect applications previously installed on system 100.

In step 302, manager 202 queries collectors 203 to detect applications previously installed on system 100.

In step 303, collectors 203 detect applications installed on system 100 using disparate detection techniques as described above.

In step 304, manager 202 receives the identifications, e.g., DB2 version 8.1, and other information, e.g., identification of installer programs that installed the applications, of the applications detected from each collector 203. In step 305, manager 202 generates a report listing the applications detected by each collector 203.

In step 306, manager 202 reviews the rules in rules database 207 to determine if there are any conflicts between the application to be installed by installer program 201 and the applications detected by collectors 203. Further, manager 202 reviews the rules in rules database 207 to determine whether to have installer program 201 install the application or instead reuse one of the applications detected by collectors 203 if there are no conflicts between the application to be installed by installer program 201 and the applications detected by collectors 203. It is noted that the rules in rules database 207 were described above in association with FIG. 2 and will not be described again for the sake of brevity.

In step 307, manager 202 determines whether there are any conflicts between the application to be installed by installer program 201 and the applications detected by collectors 203. As stated above, in one embodiment, manager 202 may determine if there are any conflicts between the application to be installed by installer program 201 and the applications detected by collectors 203 by reviewing the rules in rules database 207.

If manager 202 determines there is a conflict between the application to be installed by installer program 201 and the applications detected by collectors 203, then manager 202 determines if the conflict can be cured in step 308.

If manager 202 cannot cure the conflict, then, in step 309, installer program 201 is informed by manager 202 to not install the application.

If, however, manager 202 can cure the conflict, then, in step 310, manager 202 cures the conflict.

If manager 202 did not detect any conflicts between the application to be installed by installer program 201 and the applications detected by collectors 203 or if a detected conflict was cured by manager 202, then, in step 311, manager 202 determines if one of the detected applications could be reused instead of installing the application by installer program 201.

If manager 202 determines that one of the detected applications could be reused instead of installing the application by installer program 201, then, in step 312, manager 202 informs installer program 201 to not install the application but instead reuse of the one of the detected applications on system 100.

If, however, manager 202 determines that none of the detected applications could be reused instead of installing the application by installer program 201, then, in step 313, manager 202 informs installer program 201 to install the application.

In step 314, installer program 201 installs the application. In step 315, installer program 201 installs a detection mechanism, e.g., collector 208, on system 100 associated with the installed application. In step 316, manager 202 combines the previously installed detection mechanisms, e.g., collectors 203A-C, with the installed detection mechanism, e.g., collector 208, to be used by a subsequent installer program via manager 202 to detect applications installed on system 100. In one embodiment, manager 202 may combine the newly installed detection mechanism with the previously installed detection mechanisms by establishing a connection with the newly installed detection mechanism. Manager 202 already has connections with the previously installed diction mechanisms.

It is noted that method 300 may include other and/or additional steps that, for clarity, are not depicted. It is further noted that method 300 may be executed in a different order presented and that the order presented in the discussion of FIG. 3 is illustrative. It is further noted that certain steps in method 300 may be executed in a substantially simultaneous manner.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for detecting previously installed applications on a system comprising the steps of:
installing a first detection mechanism on said system during an installation of a first application;
invoking an application programming interface to call a manager to detect previously installed applications on said system; and
detecting previously installed applications on said system using previously installed detection mechanisms and said first installed detection mechanism.

2. The method as recited in claim 1, wherein said previously installed detection mechanisms and said first installed detection mechanism implement disparate detection techniques

3. The method as recited in claim 1, wherein said first installed detection mechanism remains on said system even if said first application is uninstalled.

4. The method as recited in claim 1 further comprising the step of:
generating a report listing said detected previously installed applications.

5. The method as recited in claim 4 further comprising the step of:
reviewing rules to determine if there any conflicts between a second application to be installed and said detected previously installed applications.

6. The method as recited in claim 5 further comprising the step of:
determining if a conflict can be cured if there is a conflict between said second application and one of said detected previously installed applications.

7. The method as recited in claim 5 further comprising the step of:
installing said second application and a second detection mechanism associated with said second application if there is no conflict between said second application and said detected previously installed applications.

8. The method as recited in claim 5 further comprising the step of:
reviewing said rules to determine if one of said detected previously installed applications can be reused instead of installing said second application.

9. A computer program product embodied in a machine readable medium for detecting previously installed applications on a system comprising the programming steps of:
installing a first detection mechanism on said system during an installation of a first application;
invoking an application programming interface to call a manager to detect previously installed applications on said system; and
detecting previously installed applications on said system using previously installed detection mechanisms and said first installed detection mechanism.

10. The computer program product as recited in claim 9, wherein said previously installed detection mechanisms and said first installed detection mechanism implement disparate detection techniques

11. The computer program product as recited in claim 9, wherein said first installed detection mechanism remains on said system even if said first application is uninstalled.

12. The computer program product as recited in claim 9 further comprising the programming step of:
generating a report listing said detected previously installed applications.

13. The computer program product as recited in claim 12 further comprising the programming step of:
reviewing rules to determine if there any conflicts between a second application to be installed and said detected previously installed applications.

14. The computer program product as recited in claim 13 further comprising the programming step of:
determining if a conflict can be cured if there is a conflict between said second application and one of said detected previously installed applications.

15. The computer program product as recited in claim 13 further comprising the programming step of:
installing said second application and a second detection mechanism associated with said second application if there is no conflict between said second application and said detected previously installed applications.

16. The computer program product as recited in claim 13 further comprising the programming step of:
reviewing said rules to determine if one of said detected previously installed applications can be reused instead of installing said second application.

17. A system, comprising:
a processor; and
a memory unit coupled to said processor, wherein said memory unit is operable for storing a computer program for detecting previously installed applications on said system;
wherein said processor, responsive to said computer program, comprises:
circuitry for installing a first detection mechanism on said system during an installation of a first application;
circuitry for invoking an application programming interface to call a manager to detect previously installed applications on said system; and
circuitry for detecting previously installed applications on said system using previously installed detection mechanisms and said first installed detection mechanism.

18. The system as recited in claim 17, wherein said previously installed detection mechanisms and said first installed detection mechanism implement disparate detection techniques

19. The system as recited in claim 17, wherein said first installed detection mechanism remains on said system even if said first application is uninstalled.

20. The system as recited in claim 17, wherein said processor further comprises:
circuitry for generating a report listing said detected previously installed applications.

21. The system as recited in claim 20, wherein said processor further comprises:
circuitry for reviewing rules to determine if there any conflicts between a second application to be installed and said detected previously installed applications.

22. The system as recited in claim 21, wherein said processor further comprises:
circuitry for determining if a conflict can be cured if there is a conflict between said second application and one of said detected previously installed applications.

23. The system as recited in claim 21, wherein said processor further comprises:
circuitry for installing said second application and a second detection mechanism associated with said second application if there is no conflict between said second application and said detected previously installed applications.

24. The system as recited in claim 21, wherein said processor further comprises:
circuitry for reviewing said rules to determine if one of said detected previously installed applications can be reused instead of installing said second application.
